(19) United States
(12) Patent Application Publication
(10) Pub. No.: US 2008/0203274 A1
(43) Pub. Date: Aug. 28, 2008

(54) Solar sensor

(76) Inventor: Martin Jeitner, Ostheim (DE)

Correspondence Address: Muncy, Geissler, Olds & Lowe, PLLC, P.O. BOX 1364, FAIRFAX, VA, 22038-1364, US

(21) Appl. No.: 12/000,017

(22) Filed: Dec. 6, 2007

Related U.S. Application Data
(63) Continuation of application No. PCT/EP2006/006313, filed on Jun. 29, 2006.

(30) Foreign Application Priority Data
Jul. 6, 2005 (DE) 102005031546
Sep. 15, 2005 (DE) 102005043955

(51) Int. Cl. G01J 1/20

(52) U.S. Cl. 250/203.4

(57) ABSTRACT

Solar sensors are used, e.g., for generating a signal for controlling air conditioning systems in motor vehicles. To accomplish this, it is necessary that the signal is representative of the so-called solar load independent of angle of incidence of sunbeams. For this purpose, the sunbeams striking the solar sensor must be appropriately scattered. This is achieved by applying a layer of hollow microbeads to the interior of the housing of the solar sensor.

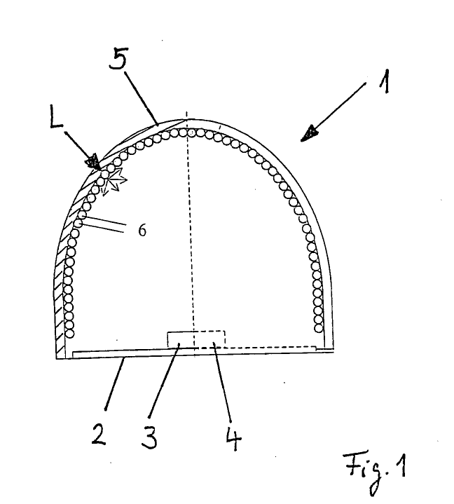

This nonprovisional application is a continuation of International Application No. PCT/EP2006/006313, which was filed on Jun. 29, 2006, and which claims priority to German Patent Application Nos. DE 102005031546 and DE 102005043955, which were filed in Germany on Jul. 6, 2005 and Sep. 15, 2005, respectively, and which are all herein incorporated by reference.

### BACKGROUND OF THE INVENTION

1. Field of the Invention

The present invention relates to a solar sensor.

2. Description of the Background Art

A sun sensor for internal temperature control systems in motor vehicles is known from European Patent No. EP 492 352 B1. The sun sensor comprises an electro-optical converter, which has a light-sensitive area. The sun sensor is equipped with a lens-shaped housing, the housing being made of a transparent material.

Unexamined German Patent Application No. DE 100 62 932 A1 discloses a signal transmitter for a control system of a motor vehicle air conditioning system. In this case, an electro-optical converter is placed below a scatter zone, integrated into a cover, for incident sunlight. The scatter zone and the electro-optical converter are disposed relative to one another in such a way that sunlight entering within a first light incidence angle area is scattered by the scatter zone before it strikes the converter. The sunlight is thereby scattered in a predefined angle area, whereas it is not scattered outside this area. The scattering of the sunlight in the first angle area achieves a reduction of the sunlight striking the converter, as a result of which signal exaggeration in this angle area is to be avoided or reduced. The scatter zone has an increased surface roughness in comparison with the remaining surface of the sensor's cover.

German Utility Patent No. DE 203 16 117 U1, on which the present invention is based, discloses a solar sensor having a converter and a radiation-transparent zone located above it, said sensor in which in this zone microbeads are provided at which light emerging from the zone is scattered.

The prior-art sensors are to emit a representative signal for the actual absorbed solar energy. In very obliquely incident light this is not always assured, however.

### SUMMARY OF THE INVENTION

It is therefore an object of the present invention to provide a solar sensor, which emits a signal in proportion to the solar load under all conditions.

In an embodiment, incident light is scattered still better because the microbeads are hollow. There are now four interfaces for the refraction of the light in each hollow microbead, and the major portion of the total refraction occurs at the interface within the hollow microbeads. As a result, light striking the light sensor is scattered equally in all directions. In this case, the material from which the beads are made is itself not very critical as long as it is sufficiently transparent. Another advantage of the hollow microbeads, compared with solid beads, is that the hollow microbeads in their interior, at the interface to the hollow space within the bead, have a second calculation index, which is independent of the media surrounding the hollow microbeads. When the hollow microbead is completely surrounded by plastic, there is also an interface that refracts incident light, in this case the second calculation index, to make available as large a scattering volume as possible. For this reason, a very representative signal for the solar radiation can be generated overall with the solar sensor of the invention, whereby the advantages described in DE 203 16 117 U1 also come to bear.

Because of the very good scattering properties, the solar sensor with a housing can be made very small.

The gluing in of the hollow microbeads or the fusion can be carried out especially well after the manufacturer of the housing, without the refracting and scattering action being impaired.

For the manufacture of the housing with the layer within a 2 k injection molding process, glass is especially suitable as a material because of its higher melting point.

Hollow microbeads with a diameter of 40 to 70 μm can be processed especially well.

When the layer is made of only one sublayer of hollow microbeads, a good optical action is achieved with a small layer thickness. According to the invention, it is also conceivable, however, to arrange a plurality of or a few sublayers of hollow microbeads one above the other. In an exemplary but not limiting calculation, at a housing thickness of about 1 mm, the number of hollow microbead sublayers is about 12 to 15 sublayers.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein the sole FIGURE illustrates a solar sensor of the invention, which has been cut in some areas.

### DETAILED DESCRIPTION

A solar sensor 1 has a printed circuit board 2 with a converter 3 and other electric or electronic components 4. A housing 5 is disposed on printed circuit board 2 such that it surrounds the converter 3 and the other components 4 at a distance. Additional electric or electronic subassemblies, which are not shown and which are connected electrically to converter 3 and/or electronic components 4, can be disposed on printed circuit board 2. Housing 5 can have, in an embodiment, the form of a cylinder with a hemisphere placed upon it and is made as a single piece. The entire interior of housing 5 is provided with a layer of hollow microbeads 6.

Housing 5 and hollow microbeads 6 are manufactured of a transparent material such as, for example, plastic and/or glass. The shape of hollow microbeads 6 is at least sphere-like. They have a diameter of preferably 40-70 μm; the scattering action of hollow microbeads 6 is not limited to a specific size.

Converter 3 is, for example, an electro-optical or an infrared converter, which generates an electric signal equivalent to the radiation. Printed circuit board 2 is electrically connected to an evaluation unit, which is not shown.

Light rays L striking housing 5 are refracted multiply and scattered as a result. The scattered light strikes converter 3, which emits a signal, representative of the light intensity, in a known manner. This signal is evaluated in the evaluation unit and used, e.g., to control an air conditioning system.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A solar sensor comprising:
a converter;
a housing disposed above the converter; and
a layer of microbeads being arranged on an interior of the housing, the microbeads being hollow.

2. The solar sensor according to claim 1, wherein the hollow microbeads are glued to the interior of the housing.

3. The solar sensor according to claim 1, wherein the hollow microbeads are fused to the interior of the housing.

4. The solar sensor according to claim 1, wherein the hollow microbeads are made of glass.

5. The solar sensor according to claim 1, wherein an outer diameter of the microbeads is 40 μm to 70 μm.

6. The solar sensor according to claim 1, wherein the layer of microbeads is made of a single sublayer or a plurality of sublayers.

7. The solar sensor according to claim 1, wherein the microbeads with a plastic forming the housing are processed in a two-component injection process.
